(19) United States
(12) Patent Application Publication
(10) Pub. No.: US 2017/0260653 A1
(43) Pub. Date: Sep. 14, 2017

(54) ECO-FRIENDLY FILAMENT USING BIOMASS AND MANUFACTURING METHOD THEREOF

(71) Applicant: Sung Jin Ahn, Busan (KR)

(72) Inventors: Sung Jin Ahn, Busan (KR); Sang Kyung Woo, Uiwang-si (KR)

(21) Appl. No.: 15/403,597

(22) Filed: Jan. 11, 2017

(30) Foreign Application Priority Data
Mar. 11, 2016 (KR) 10-2016-0029387

(51) Int. Cl. D01F 8/18; B29B 9/06; C08K 5/20; B33Y 70/00; C08K 5/42; B29B 7/90; B29C 47/00

(52) U.S. Cl. CPC D01F 8/18; B29B 7/90; B29B 9/06; B29C 47/0014; B29C 47/0004; B33Y 70/00; C08K 5/42; C08K 5/20; B29K 2105/16

(57) ABSTRACT

Provided is an eco-friendly filament using a biomass manufactured by extruding a bioplastic pellet which is formed from a bioplastic pellet composition including mixed particles including a coffee byproduct with a fatty acid content of 0.01 to 2.5 wt % or less and inorganic particles and having a size of 50 μm or less; an additive; and a plastic raw material. The inorganic particles are one or more selected from the group consisting of calcium carbonate, silica, starch, alumina, titanium dioxide, talc, kaolin, mica, sericite, zinc oxide, barium carbonate, barium sulfate, diatomaceous earth, magnesium carbonate, magnesium silicate, boron nitride, alumina, zirconium oxide, iron oxide and mica titanium. The additive is one or more selected from the group consisting of an amide-based active compound, copolyamide, ethyl methane sulfonate (EMS), ethylene bis stearamide (EBS), and D-sorbitol.

### CROSS-REFERENCE TO RELATED APPLICATIONS

This application claims priority to and the benefit of Korean Patent Application No. 10-2016-0029387 filed in the Korean Intellectual Property Office on Mar. 11, 2016, the entire contents of which are incorporated herein by reference.

### TECHNICAL FIELD

The present invention relates to an eco-friendly filament using a biomass and a manufacturing method thereof, and more particularly, to an eco-friendly filament using a biomass for manufacturing plastics manufactured by a biomass such as coffee byproducts as a 3D printer filament and a manufacturing method thereof

### BACKGROUND ART

Bioplastics mean plastics including 25 wt % or more of a biomass derived from plants such as corn, chaff, and uses plant resources in which carbon in the air is fixed by photosynthesis as a raw material to suppress the concentration of carbon dioxide in the air from being increased and reduce consumption of petroleum as a limited resource, and is degraded by microorganisms after discarding, and thus, recently, the bioplastics has received attention. Among them, plant biomass belonging to non-edible organic waste resources such as agricultural wastes, industrial wastes, and food factory byproducts, which are difficult to be used for food, has received attention as an eco-friendly carbon neutral biomass material.

Generally, cellulose-based byproducts including the coffee byproducts include fatty acids of 10 wt % to 15 wt % and the solid is an energy resource having a high calorific value of 6000 kcal or more per kg, but only some of the solid are used as a raw material of an organic fertilizer and most of the solid are incinerated or buried like general waste.

Such coffee byproducts generally have a moisture content of 20 wt % to 40 wt %, so that it is difficult to incinerate the coffee byproducts by a general method and there is a problem in that a waste liquid (about pH 4.0, COD (chemical oxygen demand) of about 5000, and SS (suspended substance) of about 13000) caused by a high moisture content at the time of disposal contaminates water or soil. Accordingly, there is a need for a method for utilizing such coffee byproducts.

In accordance with the need, in Korean Patent Registration No. 10-1550364, there is provided bioplastics using biomass such as coffee byproducts and a manufacturing method thereof. From this, plastics may be prepared by using the coffee byproducts. However, there is an inadequate aspect such that the plastics prepared by the present invention causes clogging of the filament extruder or the quality of the prepared filament is deteriorated, when being manufactured as the filament which is the material for the 3D printer to be described below.

The 3D (3-Dimension) printer is a device of fabricating a 3D object while ink of a specific material is sequentially sprayed to be stacked with a fine thickness. The use of the 3D printing has been spread in various fields. The 3D printing has been used in many manufacturers for making various models including medical human body models, household products such as toothbrushes and razors, and the like in addition to a vehicle field constituted by a plurality of components.

As a material which is currently used in the 3D printing, solid thermoplastic plastics that are free to melt and cure occupy 40% of the market. The type of the thermoplastic plastic material may be filament, particles, or powder, and among them, filament type 3D printing is faster than other types in terms of rate, so that the productivity is high and the diffusion rate is fast.

As current filament materials, polylactic acid (PLA), acrylonitrile butadiene styrene (ABS), high density polyethylene (HDPE), polycarbonate, (PC), nylon, urethane, PEI, and the like are used, and the reason is as follows.

First, since the melting point is properly high and the solidification rate after printing is fast, even if the printing rate is fast, the filament materials are not deformed and dimensional stability and form stability are good.

Second, since the melting point is properly low, extrusion is easy and production efficiency is high when filament is manufactured. In addition, when the melting point is too high, because power consumption to melt the filament is large and the components in the printer need to be made of materials capable of withstanding high temperature, unnecessary costs are increased.

However, the PLA is an eco-friendly material that is difficult to work because the printer is sticky when the PLA is melted, but is a material which is difficult to recycle, easily fragile, and needs to be carefully stored due to high moisture absorption.

ABS also has a problem in that additional operations such as ventilation after printing, or removing the smell after leaving for a long time, because of bad smell when melting are required.

### SUMMARY OF THE INVENTION

Objects of the present invention to be achieved are as follows.

The present invention has been made in an effort to provide an eco-friendly filament using a biomass and a manufacturing method thereof capable of manufacturing an eco-friendly filament for a 3D printer which is harmless to the human body, has high heat resistance, and is odorless by efficiently removing fatty acids in coffee byproducts to provide method and means for manufacturing biomass plastic.

The present invention has also been made in an effort to provide an eco-friendly filament using a biomass and a manufacturing method thereof capable of manufacturing a filament at a constant velocity without clogging an extruder when manufacturing the filament by extruding the biomass plastics and manufacturing a high-quality eco-friendly filament in which fine holes in the filament are not formed due to emission of fine gas and a thickness of the filament is constant.

An exemplary embodiment of the present invention provides an eco-friendly filament using a biomass manufactured by extruding a bioplastic pellet which is formed from a bioplastic pellet composition including mixed particles including a coffee byproduct with a fatty acid content of 0.01 to 2.5 wt % or less and inorganic particles and having a size of 50 μm or less; an additive; and a plastic raw material, wherein the inorganic particles are one or more selected from the group consisting of calcium carbonate, silica, starch, alumina, titanium dioxide, talc, kaolin, mica, sericite, zinc oxide, barium carbonate, barium sulfate, diatomaceous earth, magnesium carbonate, magnesium silicate, boron nitride, alumina, zirconium oxide, iron oxide and mica titanium, and the additive is one or more selected from the group consisting of an amide-based active compound, copolyamide, ethyl methane sulfonate (EMS), ethylene bis stearamide (EBS), and D-sorbitol.

Another exemplary embodiment of the present invention provides a manufacturing method of an eco-friendly filament using a biomass including: (a) primarily removing fatty acid by extracting coffee byproducts with a solvent; (b) secondarily removing fatty acid by mixing inorganic particles with the coffee byproducts in which the fatty acid is primarily removed; (c) grinding mixed particles including the coffee byproducts in which the fatty acid is secondarily removed and the inorganic particles; (d) preparing a bioplastic pellet by mixing and extruding the ground mixed particles, a plastic raw material, and an additive; and (e) manufacturing a filament by extruding the bioplastic pellet, wherein the solvent in step (a) is one of fermentation alcohol at room temperature, an enzyme cleanser diluent at 55° C. or less, or water at 60° C. or higher and the additive in step (d) is selected from the group consisting of an amide-based active compound, copolyamide, ethyl methane sulfonate (EMS), ethylene bis stearamide (EBS), and D-sorbitol.

The present invention exhibits the following effects.

According to the exemplary embodiment of the present invention, it is possible to manufacture an eco-friendly filament for a 3D printer which is harmless to the human body, has high heat resistance, and is odorless by efficiently removing fatty acids in coffee byproducts to provide method and means for manufacturing biomass plastic.

It is also possible to manufacture a filament at a constant velocity without clogging an extruder when manufacturing the filament by extruding the biomass plastics and manufacture a high-quality eco-friendly filament in which fine holes in the filament are not formed due to emission of fine gas and a thickness of the filament is constant.

### BRIEF DESCRIPTION OF THE DRAWINGS

FIG. 1 is a block diagram illustrating a manufacturing method according to an exemplary embodiment of the present invention.

FIG. 2 is a photograph of a filament (b) manufactured according to Example of the present invention and a filament (a) manufactured according to Comparative Example.

FIG. 3 is a block diagram illustrating a schematic configuration of a manufacturing apparatus used in an exemplary embodiment of the present invention.

FIG. 4 is a diagram illustrating an oil absorption means 90 provided in a stirrer 1 of the present invention.

FIGS. 5 and 6 are photographs for heat resistance tests of a general PLA filament and a coffee PLA filament.

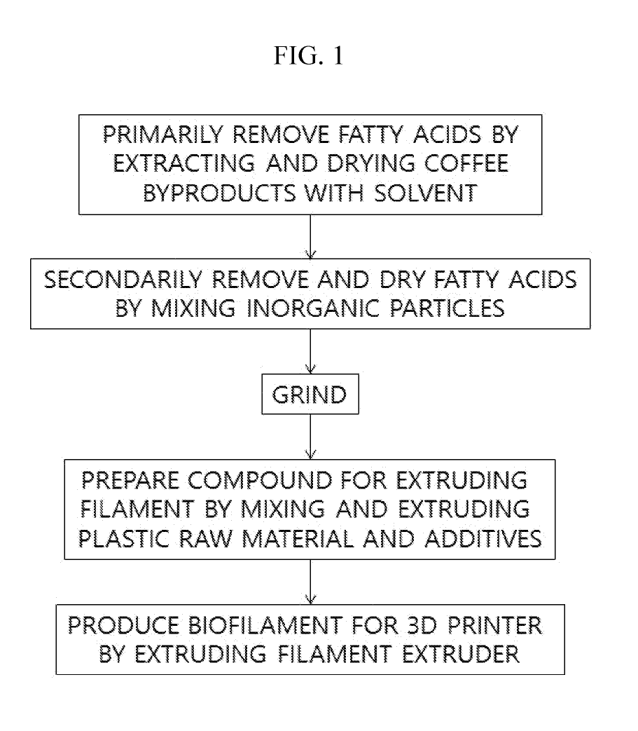

### DETAILED DESCRIPTION

Hereinafter, preferred exemplary embodiments of the present invention will be described with reference to the accompanying drawings. However, the scope of the present invention needs to be identified by disclosure of claims. Further, description of known techniques which obscure the gist of the present invention will be omitted.

The present invention is first summarized as follows.

That is, the present invention relates to an eco-friendly filament using a biomass manufactured by extruding a bioplastic pellet which is formed from a bioplastic pellet composition including mixed particles including a coffee byproduct with a fatty acid content of 0.01 to 2.5 wt % or less and inorganic particles and having a size of 50 μm or less; an additive; and a plastic raw material, wherein the inorganic particles are one or more selected from the group consisting of calcium carbonate, silica, starch, alumina, titanium dioxide, talc, kaolin, mica, sericite, zinc oxide, barium carbonate, barium sulfate, diatomaceous earth, magnesium carbonate, magnesium silicate, boron nitride, alumina, zirconium oxide, iron oxide and mica titanium, and the additive is one or more selected from the group consisting of an amide-based active compound, copolyamide, ethyl methane sulfonate (EMS), ethylene bis stearamide (EBS), and D-sorbitol.

The present invention relates to a manufacturing method of an eco-friendly filament using a biomass including: (a) primarily removing fatty acid by extracting coffee byproducts with a solvent; (b) secondarily removing fatty acid by mixing inorganic particles with the coffee byproducts in which the fatty acid is primarily removed; (c) grinding mixed particles including the coffee byproducts in which the fatty acid is secondarily removed and the inorganic particles; (d) preparing a bioplastic pellet by mixing and extruding the ground mixed particles, a plastic raw material, and an additive; and (e) manufacturing a filament by extruding the bioplastic pellet, wherein the solvent in step (a) is one of fermentation alcohol at room temperature, an enzymatic cleaner diluent at 55° C. or less, or water at 60° C. or higher and the additive in step (d) is selected from the group consisting of an amide-based active compound, copolyamide, ethyl methane sulfonate (EMS), ethylene bis stearamide (EBS), and D-sorbitol.

In the present invention, as the biomass for preparing the bioplastic, coffee byproducts are used.

In this specification, the ‘coffee byproducts’ refer to grounds remaining after extracting coffee from coffee beans and the coffee byproducts may be generated after preparing drip coffee (Dutch coffee) or instant coffee. Particularly, when the grounds generated after preparing the drip coffee (Dutch coffee) is used as the biomass for preparing the bioplastics as it is due to the high fatty acid content of about 20 to 30 wt %, there is a problem in that the quality of the bioplastics is largely deteriorated by a sticky effect due to the fatty acid component.

In order to solve the above problem, it is required to efficiently remove the fatty acid as the coffee byproduct, particularly, the drip coffee (Dutch coffee) byproduct.

Particularly, the preparing method of the bioplastics according to the present invention includes primarily removing the fatty acid by extracting the coffee byproducts with a solvent (step (a)).

The primary removal of the fatty acids may be performed by extracting and drying the solvent from the coffee byproducts, and the solvent for primarily removing the fatty acids uses preferably fermented alcohol having an alcohol concentration of 90% (v/v) to 99% (v/v) and more preferably fermented alcohol having an alcohol concentration of 95% (v/v) to 99% (v/v), but is not limited thereto.

The fermented alcohol is a kind of ethanol prepared by a method of fermenting sugar by yeast and corresponds to a vegetable-derived solvent to have an eco-friendly advantage. In this case, the alcohol concentration of the fermented alcohol maintains the range to have an advantage of efficiently extracting the fatty acids in the coffee byproducts.

As the solvent for primarily removing the fatty acids, an enzymatic cleaner dilute may be used.

An example of the enzymatic cleaner may be Tergazyme® by Alconox Corporation.

The Tergazyme is a powder cleaner including an active enzyme and consist of a mixture of sulfonate with an alkaline group, phosphate, carbonate, and protease.

The Tergazyme enzymatic cleaner contains a strong emulsifier component to remove organic/oily residues such as fatty acids in the coffee byproducts.

The enzymatic cleaner dilute means that the enzymatic cleaner is diluted in warm water, and in the case of using the Tergazyme, the Tergazyme enzymatic cleaner is diluted in warm water of 55° C. or less with 0.1 to 2 wt % and more preferably, an enzymatic cleaner dilute in which the Tergazyme enzymatic cleaner is diluted in warm water of 35 to 50° C. or less with 1 wt % is used.

In this case, the reason why the temperature is set to 55° C. or less is that an excessively high temperature interferes with the enzyme and the enzyme activity.

However, the enzymatic cleaner dilute is not limited to the cleaner, but any enzymatic cleaner including an emulsifier component capable of removing bio-based contamination may be applied by properly varying a concentration.

A solvent extraction process of the coffee byproducts by using the fermented alcohol, the enzymatic cleaner, and the like as a solvent when primarily removing the fatty acid is performed in the stirrer 1.

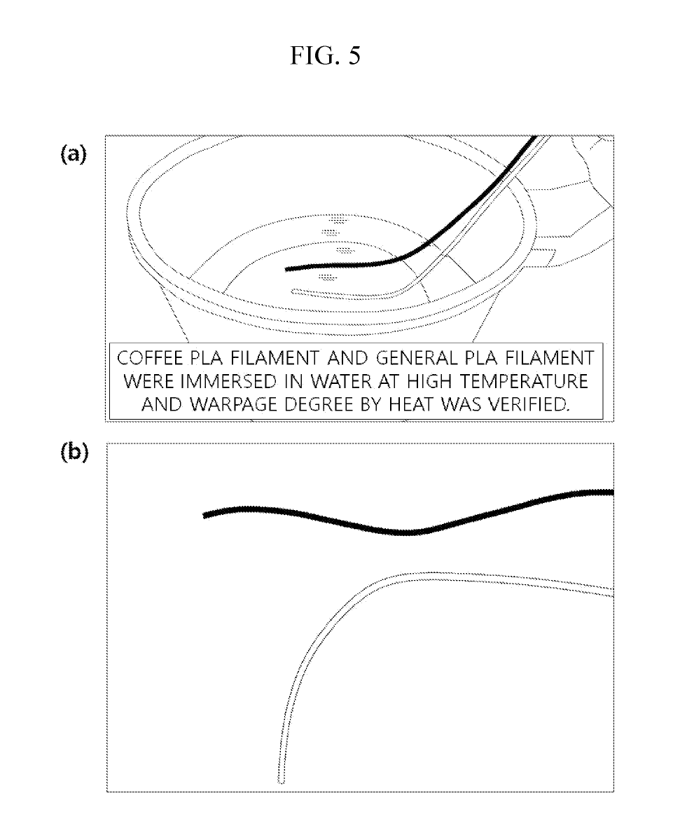

In this process, as illustrated in FIG. 5, an oil absorption means 90 may be additionally provided in the stirrer 1.

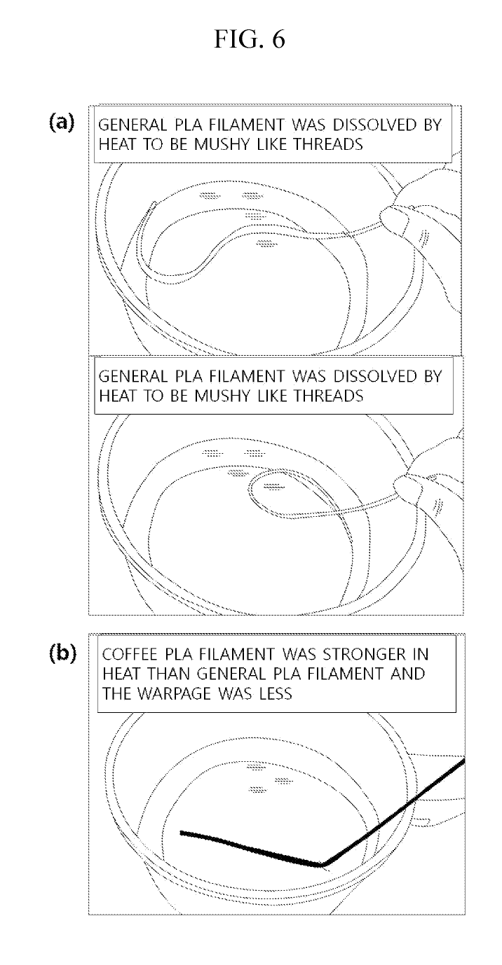

The oil absorption means 90 is connected to a rotation shaft to rotate in the stirrer during stirring and may have a skein shape as illustrated in FIG. 6.

The oil absorption means 90 is constituted by a frame 91 and an oil absorption portion 92.

The frame 91 has bar or mesh inner and outer boundaries so that the coffee byproducts and the solvent flow into and out and is made of a non-reacted material with the solvent added into the stirrer 1, such as stainless.

The oil absorption portion 92 is formed in the frame 91 so that the fatty acids in the coffee byproducts are coagulated when the coffee byproducts and the solvent flow into and out, and preferably has a thread-wound shape as illustrated in FIG. 6, and general threads may be used.

That is, on the bar or mesh boundaries of the frame 91, while the coffee byproducts and the solvent flow into and out of the oil absorption means 90, the fatty acids of the coffee byproducts are coagulated in the oil absorption portion 92 such as threads.

As a result, the fatty acids of the coffee byproducts may be more efficiently removed by additionally providing the oil absorption means 90 as well as removing the fatty acids by the solvent.

The solvent extraction process of the coffee byproducts when primarily removing the fatty acids may be performed by the following method.

That is, the method is a boiling method using water other than a separate solvent as the solvent.

In this case, since the fatty acids in the coffee byproducts are dissolved in water when heating at a high temperature for a long time, grease on the water is removed when cooled to easily remove the fatty acids in the coffee byproducts.

The boiling is performed by introducing the coffee byproducts into boiling water above 100° C. and heating the coffee byproducts for 1 hr or more.

Preferably, the boiling is performed by heating the coffee byproducts in water at 100° C. for 3 to 6 hrs by setting a weight ratio of water and the coffee byproducts to 8:2.

When the heating time is 3 hrs or less, an oil removal rate is decreased to 40% or less and in the case of 6 hrs or more, costs and productivity are decreased.

The heating may be performed twice within a total heating time.

In this case, the stirrer 1 may be replaced with a boiler and an oil absorption means may also be additionally provide in the boiler.

However, since the fatty acids may be dissolved for a long time in water at about 50 to 60° C. or more which is a melting temperature of the fat, the temperature and the heating time of water may be adjusted in a range of at least 60° C. or more and 1 hr or more.

It is preferred that the extraction temperature is maintained at room temperature (20 to 30° C.) in the case of the fermented alcohol as the solvent, a temperature (35 to 50° C.) of the enzymatic cleaner diluent in the case of the enzymatic cleaner diluent, and a boiling temperature (100° C. or more) in the case of water, and the extraction time is preferably 1 to 10 hrs and more preferably 3 to 4 hrs at room temperature, but is not limited thereto. In this case, the extraction rate depends on the temperature, but it is preferable that extraction is performed at room temperature.

In this case, when the extraction temperature is too low, there is a problem in that fatty acid is not effectively extracted, and when the extraction temperature is too high, there is a problem in that unnecessary energy is consumed.

The drying may be performed in a dryer 3 by various known methods such as vacuum drying, hot air drying and air stream drying and may be preferably performed in vacuum at 90° C. to 100° C., but is not limited thereto. At this time, when the drying is performed at a temperature of less than 90° C., there is a problem in productivity due to a slow drying rate, and when the drying is performed at a temperature of more than 100° C., there is a problem in that the drying cost is increased and oil, that is, oil refining may occur in the coffee byproducts including moisture.

As such, the remaining solvent after primarily removing the fatty acids may be separated and collected by a centrifuge 2 and the collected remaining solvent may be used for primarily removing the fatty acids of the coffee byproducts after removing oil and water through zeolite, bentonite, and the like by an additional stirrer 4.

Next, the preparing method of the bioplastics according to the present invention includes removing secondarily the fatty acids by mixing the coffee byproducts in which the fatty acids are primarily removed and inorganic particles (step (b)).

The second removal of the fatty acids may be performed by controlling mixing the inorganic particles with the coffee byproducts, and the inorganic particles additionally absorb the fatty acid and moisture in the primarily removed coffee byproducts, and serve to enhance the mechanical properties such as breaking force and shearing force of the finally prepared bioplastics.

An average particle size of the inorganic particles may be 3 μm to 10 μm, but is not limited thereto. In this case, when the average particle size is less than 3 μm, there is a problem in that the inorganic particles are coagulated due to excessive attraction and thus not sufficiently impregnated into the coffee byproducts, and when the average particle size exceeds 10 μm, there is a problem in that the particle size of the inorganic particles is large and thus not sufficiently impregnated into the coffee byproducts well.

The inorganic particles are mixed with 20 wt % to 30 wt % with respect to the coffee byproducts in which the fatty acids are primarily removed, but are not limited thereto. In this case, when the content of the inorganic particles is less than 20 wt %, there is a problem that miscibility is poor, and when the content of the inorganic particles is more than 30 wt %, there is a problem that the mechanical properties of the finally prepared bioplastics are significantly deteriorated.

The inorganic particles may be one or more selected from the group consisting of calcium carbonate, silica, starch, alumina, titanium dioxide, talc, kaolin, mica, sericite, zinc oxide, barium carbonate, barium sulfate, diatomaceous earth, magnesium carbonate, magnesium silicate, boron nitride, alumina, zirconium oxide, iron oxide and mica titanium, but are not limited thereto.

After the mixing, drying may be selectively performed. The drying may be performed by various known methods such as vacuum drying, hot air drying and air stream drying and may be preferably performed in vacuum at 90° C. to 100° C., but is not limited thereto. At this time, when the drying is performed at a temperature of less than 90° C., there is a problem in productivity due to a slow drying rate, and when the drying is performed at a temperature of more than 100° C., there is a problem in that the drying cost is increased and oil, that is, oil refining may occur in the coffee byproducts including moisture.

Next, the preparing method of the bioplastics according to the present invention includes grinding mixed particles including the coffee byproducts in which the fatty acids are secondarily removed and the inorganic particles (step (c)).

As such, the coffee byproducts in which the fatty acids are secondarily removed are characterized by minimizing the fatty acid content in the coffee byproducts and the coffee byproducts are not aggregated with each other and thus the mixed particles may be evenly ground. The grinding may be selected from dry grinding or wet grinding by considering grinding efficiency and performed by using various known methods such as ball milling or pin milling.

The fatty acid content in the coffee byproducts in which the fatty acid is secondarily removed may be 2.5 wt % or less and preferably 2.1 wt % or less, and the moisture content in the coffee byproducts in which the fatty acid is secondarily removed may be 3 wt % or less and preferably 1 wt % or less.

As such, the fatty acid content and the moisture content in the coffee byproducts in which the fatty acid is secondarily removed are minimally maintained to remove the fatty acids from the coffee byproducts by a complex method.

Next, the preparing method of the bioplastics according to the present invention includes preparing a bioplastic pellet by mixing and extruding the ground mixed particles with a plastic raw material and an additive (step (d)).

The average particle size of the ground mixed particles is preferably 50 μm or less. When the average particle size is larger than 50 μm, the extruder is clogged when the filament is manufactured, or the filament is not manufactured at a constant thickness. As such, the fact that the particle sizes of the ground mixed particles are small and evenly dispersed is a result which is largely dependent on the result from low fatty acid content and water content in the coffee byproducts.

A weight ratio of the ground mixed particles and the plastic raw material may be in a range of 1:100 to 66:100, but is not limited thereto.

The plastic raw material may be selected from materials which are frequently used as a 3D printer filament material, such as polylactic acid (PLA), acrylonitrile butadiene styrene (ABS), high density polyethylene (HDPE), polycarbonate (PC), nylon, urethane, and PEI.

Among them, the PLA referred to in the exemplary embodiment of the present invention is an eco-friendly resin made from raw materials extracted from corn starch and harmless to the human body and an environment, but the mixing action of the ground mixed particles and the plastic raw material such as PLA does not occur well, and clogging of the extruder and the like are caused even in the extrusion process for manufacturing the filament.

Accordingly, in order to manufacture a large amount of good-quality filament, the plastic raw material and the ground mixed particles may be mixed well and an additive needs to be additionally added so that the bioplastic pellet capable of stably manufacturing the filament is made.

The additive may be one or more selected from the group consisting of an amide-based active compound, copolyamide, ethyl methane sulfonate (EMS), ethylene bis stearamide (EBS), and D-sorbitol.

An example of the amide-based active compound may be TR016 by Struktol Corporation and plays a crucial role in the binding of the PLA as a fatty acid metal soap and amide compound and the biomass.

The amide component included in the amide-based active compound may serve as a physical binder of polymer and filler acid due to hydrogen bonding. Accordingly, the amide-based active compound is added to act as a very efficient mixing/dispersing agent and may be a more uniform compound.

The amide-based active compound may be preferably added with 0.1 to 5 wt % based on TR016, but the range may be adjusted according to components and a concentration of the compound and other additive amounts.

An example of copolyamide may be D1549A by Griltex Corporation and heat stabilized copolyamide may be preferably added with 0.1 to 5 wt % based on the D1549A. However, the range may be adjusted according to components and a concentration of the compound and other additive amounts.

The ethyl methane sulfonate (EMS) may be added with 0.1 to 5 wt %, the ethylene bis stearamide (EBS) may be added with 0.1 to 5 wt %, and the D-sorbitol may be added with 1 to 10 wt %, but the range may be adjusted according to components and a concentration of the compound and other additive amounts.

The extruding is performed through various known methods using a uniaxial, biaxial or kneader extruder and the like to prepare the bioplastic pellet.

Next, the preparing method of the bioplastics according to the present invention includes manufacturing the filament by extruding the bioplastic pellet (step (e)).

The prepared bioplastic pellet is added to the extruder for manufacturing the filament to manufacture a filament for a 3D printer.

When the bioplastic pellet is added to the extruder for manufacturing the filament, the filament may be manufactured at a constant rate without clogging of the extruder. Further, a high-quality filament may be manufactured in which fine holes in the filament are not formed due to emission of fine gas and a thickness of the filament is constant.

The present invention provides an eco-friendly filament using a biomass manufactured by extruding a bioplastic pellet which is formed from a bioplastic pellet composition including mixed particles including a coffee byproduct with a fatty acid content of 0.01 to 2.5 wt % or less and inorganic particles and having a size of 50 μm or less; an additive; and a plastic raw material.

The inorganic particles may be one or more selected from the group consisting of calcium carbonate, silica, starch, alumina, titanium dioxide, talc, kaolin, mica, sericite, zinc oxide, barium carbonate, barium sulfate, diatomaceous earth, magnesium carbonate, magnesium silicate, boron nitride, alumina, zirconium oxide, iron oxide and mica titanium and more preferably calcium carbonate, but are not limited thereto.

The additive may be one or more selected from the group consisting of an amide-based active compound, copolyamide, ethyl methane sulfonate (EMS), ethylene bis stearamide (EBS), and D-sorbitol.

The plastics may be one or more selected from the group consisting of polylactic acid (PLA), acrylonitrile butadiene styrene (ABS), high density polyethylene (HDPE), polycarbonate (PC), nylon, urethane, PEI and combinations thereof.

However, the plastics are not limited thereto.

Hereinafter, preferred Examples for helping in understanding of the present invention are proposed. However, the following Examples are provided for more easily understanding the present invention and the contents of the present invention are not limited by the following Examples.

In steps (a) to (c), preferred Examples and effects are disclosed in Korean Patent Registration No. 10-1550364 and Examples will be proposed based on steps (d) and (e).

### EXAMPLES

### Example 1

Step (d): 5.5 g of the mixed particles ground in step (c), PLA 110 g, D1549A 5.5 g, EMS 5.5 g, and TR016 1.1 g as additives were mixed and extruded at a feeder rate of 20 to 40 RPM at 160 to 170° C. to prepare a bioplastic pellet.

Step (e): The extruded bioplastic pellet was extruded in a filament extruder at 180 to 200° C. to manufacture a filament.

### Example 2

Step (d): 20 g of the mixed particles ground in step (c), PLA 200 g, D1549A 20 g, EMS 2 g, TR016 1 g, D-sorbitol 6 g, and POE 6 g as additives were mixed and extruded at a feeder rate of 20 to 40 RPM at 160 to 170° C. to prepare a bioplastic pellet.

Step (e): The extruded bioplastic pellet was extruded in a filament extruder at 180 to 200° C. to manufacture a filament.

### Example 3

Step (d): 30 g of the mixed particles ground in step (c), PLA 200 g, EMS 4 g, TR016 2 g, and POE 4 g as additives were mixed and extruded at a feeder rate of 20 to 40 RPM at 160 to 170° C. to prepare a bioplastic pellet.

Step (e): The extruded bioplastic pellet was extruded in a filament extruder at 180 to 200° C. to manufacture a filament.

### Comparative Example

Step (d): 11 g of the mixed particles ground in step (c) and PLA 110 g were mixed without additives and extruded at a feeder rate of 20 to 40 RPM at 160 to 170° C. to prepare a bioplastic pellet.

Step (e): The extruded bioplastic pellet was extruded in a filament extruder at 180 to 200° C. to manufacture a filament.

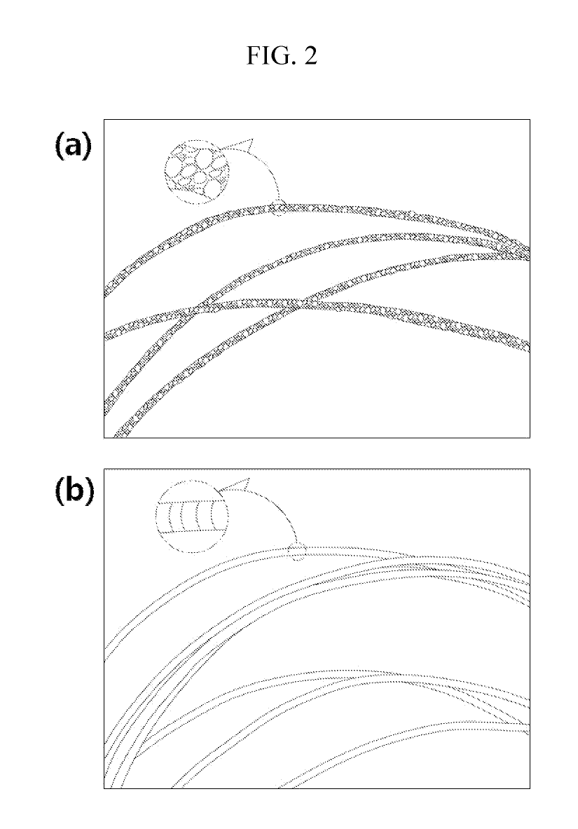

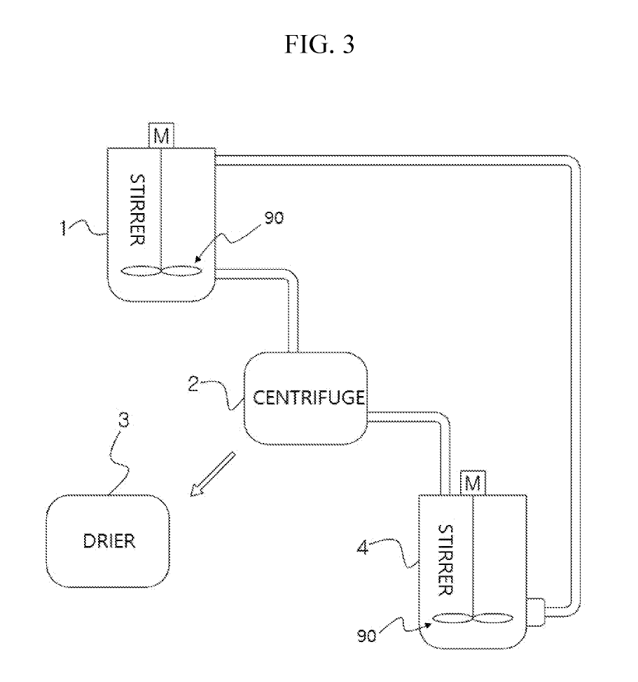

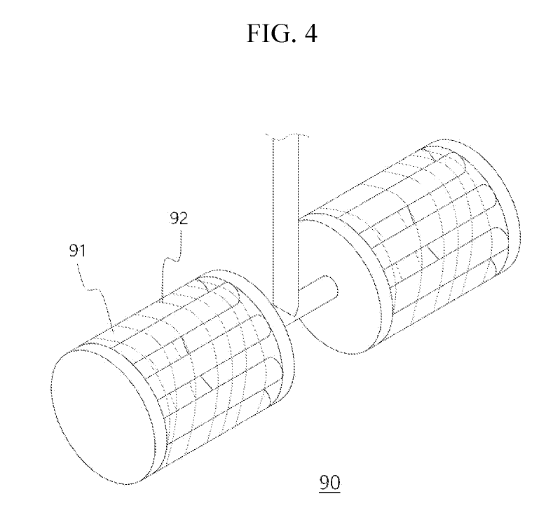

In Examples 1 to 3 in which the additives were added, the bioplastic pellet was extruded at a constant rate without clogging of the extruder, and as illustrated in (b) of FIG. 2, the filament having a smooth surface and a uniform thickness was stably manufactured.

However, in comparative example, clogging of the extruder occurred, the extrusion rate was not constant, and as illustrated in (a) of FIG. 2, fine holes were formed in the filament due to gas generation, and thus because the surface was rough and the thickness was not uniform, the filament which was not suitable to be used for the 3D printer was manufactured.

The filament manufactured according to Example 1 was referred to as a coffee PLA filament, and a conventional PLA filament was referred to as a general PLA filament, and heat resistance for two filaments was tested.

In FIGS. 5 and 6, a brown filament corresponds to a coffee PLA filament, and a white filament corresponds to a general PLA filament.

In a first test, as illustrated in (a) of FIG. 5, the filament was immersed in water at a temperature of approximately 100° C. for a predetermined time, and then taken out, and the warpage degree of the filament was verified. As a result, as illustrated in (b) of FIG. 5, the general PLA filament was dissolved by heat and warpage up to an angle of 90° occurred, but the coffee PLA filament kept an original shape without almost warpage.

In a second test, as illustrated in (a) of FIG. 6, while the filament was immersed in water at a temperature of approximately 100° C., the degree of warpage of the filament was verified. As a result, as illustrated in (b) of FIG. 6, the general PLA filament was dissolved by heat and then a thread-like mushy phenomenon occurred, but the coffee PLA filament firmly kept an original shape without the mushy phenomenon.

As verified from the above experiment, the coffee PLA filament according to the present invention reinforces a low heat-resistant surface, which is a disadvantage of the conventional PLA filament, and simultaneously, because there is no odor generated in the ABS filament, immediately after printing, there is no problem in using an output product and ventilation is not required.

The present invention exhibits the following effects.

It is possible to manufacture an eco-friendly filament for a 3D printer which is harmless to the human body, has high heat resistance, and is odorless by efficiently removing fatty acids in coffee byproducts to provide method and means for manufacturing biomass plastic.

It is possible to manufacture a filament at a constant velocity without clogging an extruder when manufacturing the filament by extruding the biomass plastics and manufacture a high-quality eco-friendly filament in which fine holes in the filament are not formed due to emission of fine gas and a thickness of the filament is constant.

The aforementioned present invention is not limited to the aforementioned exemplary embodiments and the accompanying drawings, and it will be obvious to those skilled in the technical field to which the present invention pertains that various substitutions, modifications, and changes may be made within the scope without departing from the technical spirit of the present invention.

What is claimed is:

1. An eco-friendly filament using a biomass manufactured by extruding a bioplastic pellet which is formed from a bioplastic pellet composition including mixed particles including a coffee byproduct with a fatty acid content of 0.01 to 2.5 wt % or less and inorganic particles and having a size of 50 μm or less; an additive; and a plastic raw material,
wherein the inorganic particles are one or more selected from the group consisting of calcium carbonate, silica, starch, alumina, titanium dioxide, talc, kaolin, mica, sericite, zinc oxide, barium carbonate, barium sulfate, diatomaceous earth, magnesium carbonate, magnesium silicate, boron nitride, alumina, zirconium oxide, iron oxide and mica titanium, and
the additive is one or more selected from the group consisting of an amide-based active compound, copolyamide, ethyl methane sulfonate (EMS), ethylene bis stearamide (EBS), and D-sorbitol.

2. A manufacturing method of an eco-friendly filament using a biomass, comprising:
(a) primarily removing fatty acid by extracting coffee byproducts with a solvent;
(b) secondarily removing fatty acid by mixing inorganic particles with the coffee byproducts in which the fatty acid is primarily removed;
(c) grinding mixed particles including the coffee byproducts in which the fatty acid is secondarily removed and the inorganic particles;
(d) preparing a bioplastic pellet by mixing and extruding the ground mixed particles, a plastic raw material, and an additive; and
(e) manufacturing a filament by extruding the bioplastic pellet,
wherein the solvent in step (a) is one of fermentation alcohol at room temperature, an enzymatic cleaner diluent at 55° C. or less, or water at 60° C. or higher and
the additive in step (d) is selected from the group consisting of an amide-based active compound, copolyamide, ethyl methane sulfonate (EMS), ethylene bis stearamide (EBS), and D-sorbitol.

3. The manufacturing method of claim 2, wherein in step (a), an oil absorption means is further included in the stirrer 1 which extracts the coffee byproducts with a solvent,
the oil absorption means is constituted by a frame having bar or mesh inner and outer boundaries so that the coffee byproducts and the solvent flow into and out and
an oil absorption portion formed in the frame so that the fatty acids in the coffee byproducts are coagulated when the coffee byproducts and the solvent flow into and out, and
on the boundaries of the frame, while the coffee byproducts and the solvent flow into and out of the oil absorption means, the fatty acids of the coffee byproducts are coagulated in the oil absorption portion.
